(19) United States
(12) Patent Application Publication
(10) Pub. No.: US 2011/0025040 A1
(43) Pub. Date: Feb. 3, 2011

(54) METHOD AND APPARATUS FOR NOTIFICATION OF GUARDIANS OF LOCATION OF LOST PERSONS

(76) Inventors: RANDY ALAN DOMINGUEZ, Bonsall, CA (US); Walter Mazzota, Jupiter, FL (US)

Correspondence Address: DONN K. HARMS;PATENT & TRADEMARK LAW CENTER, SUITE 100, 12702 VIA CORTINA, DEL MAR, CA, 92014, US

(21) Appl. No.: 12/902,117

(22) Filed: Oct. 11, 2010

Related U.S. Application Data
(63) Continuation-in-part of application No. 10/850,711, filed on May 20, 2004, now Pat. No. 7,810,844.

(51) Int. Cl. B42D 15/00

(52) U.S. Cl. 283/75

(57) ABSTRACT

A method and apparatus for identifying a lost person and providing contact information for a third part to directly communicate with their guardian. The method and apparatus provided an imparting of indica bearing the cellular phone number of the guardian to the potentially lost person. A temporary tattoo is employed to carry the indica on a planar member affixed to the skin or by affixing the planar member to the potentially lost person. Verification instructions as to the guardian identity are also provided by instructions to dial the responding guardian when in the presence of the third party or to inspect the cellular phone of the guardian for its displayed number.

This application is a Continuation in Part Application to U.S. patent application Ser. No. 10/850,711, filed on May 20, 2004 and currently pending, and included herein in its entirety by reference.

### BACKGROUND OF THE INVENTION

1. Field of the Invention

The present invention relates to parental or guardian notification of lost children and a means to identify the parent or guarding to the responding party. More particularly, the device and method herein disclosed relates to a method of providing responding third parties, to a lost child or adult at a venue remote from their home or during travel, a manner in which to contact the parents or guardian of a lost child or other individual, through a placement of indicia which may be temporarily applied to the child or individual. This temporarily placed indica is adapted to be read and understood by third parties.

2. Prior Art

Small children accompanying their parents, older siblings, other children with a teacher or guardian frequently visit venues remote from their home, such as amusement parks, museums, sporting events, hotels, field trips, and numerous other events where children can accidentally become separated from the person charged with watching them. Frequently, very small children will be unable to converse with anyone finding them due to a lack of developed language skills or fear. Toddlers, even with a reasonable command of the language, frequently are unable to identify their parents or guardian or home in any reasonable fashion that enables third parties to ascertain the child's identity or the parent's or guardian's identity or contact information. Such is the same for older adults suffering dementia or other mental handicaps, or who are otherwise verbally handicapped individuals.

Consequently, a third party finding a lost child or individual, who cannot reasonably identify themselves or their parents or guardian, is left with little option other than calling the police or security at the venue where the child becomes lost. The arriving police are left with even less options in that they generally must take the individual into custody while their guardian is located. This can be a real trauma for child or adult alike.

In years past, children have had tags hung on their clothing or around their necks, having indicia thereon which might provide their identification to such third parties. However, such tags are easily lost or damaged and do not provide a parent or guardian the security that they will be immediately notified if the child or other individual becomes lost.

Other identification systems have been used which place an identification number on a card which might be attached to clothing and which employs a third party intermediary such as a security company. A third party reading the card can contact the third party intermediary and let them know the child is found. The third party intermediary, which is usually a commercial firm, thereafter contacts the parent or guardian.

However, such identification cards are easily detached from the child's body or clothing or can become damaged. Further, the need to contact a third party to notify the parent or guardian increases the duration of the lost individual and the complication of just reuniting a small and possibly scared child, or distressed older adult, with a parent or guardian in the shortest amount of time.

As such, what is needed in the case of lost small children, or lost or mentally handicapped adults, or other persons who are verbally or otherwise communication-handicapped from identifying themselves, is a method and device providing such individuals with temporary identification that is not easily lost or damaged. Such a temporary identification should not only provide discernable means to identify the child or lost individual, and hence their parent or guardian, it should also provide sufficient information for the third person finding the lost child or adult, to directly contact the parent or guardian without the need to interface through a business or other third party. A small, scared child generally just wants to hear a parent's voice and get back to that parent as fast as possible. The same is true of a lost older person who generally will be distressed until seeing a familiar face. Consequently such a device should be employable using imparted information immediately discernable to the naked eye of the individual finding a lost person, and it should not require any electronic or other means to interpret the information.

### SUMMARY OF THE INVENTION

The method and device herein disclosed provides temporarily placed indicia, upon the body of a child or adult, as an immediately discernable means for an unrelated third party to identify the child or adult. Further, the information contained in the imparted indicia provides immediately discernable information to third parties on how to contact a party responsible for their well being. Still further, using conventional temporary tattoos and the like as the means to carry the imparted indica on the individual, the resulting imparted indica containing such contact and identification information, cannot be easily removed or lost. The employment of such conventional tattoos or other means for temporary applique of indicia to the person thereby provide a secure means for small children and mentally challenged adults to be identifiable and thereby allows third parties to directly contact the parents or guardian of the lost person using only the information which is incorporated into the applied indicia and which is visually available to the naked eye. Of course location of the imparted indicia may also be on a hidden part of the body should the parent, guardian, or security personnel at a particular venue so desire.

Other information may also be incorporated into the applied information imparted to the child or individual using a conventional temporary tattoo or other means of temporary placement on an individual. As is well known to those skilled in the art, temporary tattoos come in several forms which have been used for decades, and new modes of temporary impartation of indicia to a human body are being provided every year due to the development of new inks and new means of temporary indicia adhesion.

Such conventional temporary tattoos are conventionally formed of materials intended to last for a few days and to adhere to the user and appear substantially as a conventional tattoo. One long used mode of temporary tattoos employs a stick-on decal which is really a very thin layer of plastic having indicia and means for adhesion thereon which can last on the surface of the skin for a few days to about a week at most. Or using non permanent transferable inks, indica may be imparted to a sheet of plastic or paper which may be thereafter imparted to the skin of user. Such conventional temporary tattoos whether on thin plastic with adhesive quality or of transferable inks directly applied to dye the skin, generally employ non-water-based so that they don't run or smear when users sweat or get wet. This ensures the provision of sufficient readable indicia concerning information required for third party identification of the individual or child to be identified or matched with a database for contact with parents or guardians, or other authorized individuals in the case of a lost child being found by a third party.

The term “child” used throughout this application is also intended to include young adults who may be unable to care for themselves due to some physical or mental disability, and/or older adults who are unable to care for themselves in a venue remote from their home or a public situation or during travel or a walk unsupervised, due to illness such as Alzheimer's, or who are simply confused due to advanced age. The disclosed device and method would work well should either a child or an adult become separated from their care giver, parent or guardian.

In addition to information on how to contact the parent or other responsible party directly, the temporarily placed indicia can also contain the child's name and a cartoon or a theme parks identifying logo or one of their characters or something that is associated with a particular venue's branding image, which will help to provide an incentive for young children to be eager for application of the indicia to their skin or other means of applique to their person. Knowing that the indica containing the information has been placed on their person, such an indicia applique or temporary tattoo will also empower the child or lost adult since they will be very cognizant of the location of the identifying indica and its purpose.

Each such temporary tattoo for each individual child can be generated using a conventional PC style computer, operatively connected to a printer capable of producing the customized temporary tattoos or other means of imparting to the wearer, the correct information in the form of indica to provide a third party finding the child or adult, the ability to call the person by name and to contact their parent or guardian directly, without an interface through a service or other third party.

In use, in a venue such as an amusement park, the beach, during travel at a hotel, or at any venue remote to their home, the child would visit a booth or other location at or near the entrance or could also be generated by computer input from a remote location and either mailed to the parent or delivered to a parent on entry to the venue, where the information indicia would be imparted to their person using a temporary tattoo or other means to adhere the indicia to their person. The information indicia imparted to their person may be printed or hand applied or employ combinations of such and should include identification information for the child or adult. Such imparted information may be generated based on information provided by the parent or guardian.

So discerned, the desired identification information in the form of printed or written or otherwise imparted indica, which may be temporarily imparted to the person of the child or adult, is then applied to the person of the child or adult, preferably to their skin on a temporary basis. As noted, one long-used conventional mode of indicia impartation employs temporary tattoos which in one mode employ a thin plastic sheet or transferable ink tattoos with indicia imparted thereto and adheres to the skin in a manner equivalent to a sticker. The thin plastic takes on the skin color of the user thereby appearing as a tattoo but is fully removable. As can be discerned by those skilled in the art, conventional temporary tattoos using this mode of adhesion could also act as a sticker which might also be placed on clothing if desired by the venue personnel employing it or the parent, or in case the child does not want adherence to their skin, or if such is preferred due to allergies or other reasons of the parent or guardian.

The preferred information imparted to each individual would be specific to the individual child or adult to which the imparted indicia containing the information is applied. Should the venue be an amusement park or similar venue, the information may include one or a combination of the wearer or individual's name, their age, their parent or guardian's cell phone number, the individual's primary language spoken, any allergies or medical conditions, a venue logo, the individual's blood type, the individual's eye and hair color, a photo image of the responsible parent or guardian, and/or a consent to treatment in case of injury. In addition to one or a combination of the above information, for other venues such those encountered in travel such as airport, hotel, or plane, the information may include one or a combination of, information about flight number & time & destination, cabin number, hotel room number and/or name.

For a use or venue involving children going to school either walking or riding the bus, or taking field trips, in addition to any one or combination of the above information, additional indicia bearing more information may be included as to add the bus number, teacher's name, classroom number, and/or the wearer's school.

Employed at a sporting event, in combination or in addition to any indicia containing the above information, other indicia concerning which section, row and seat number the family is sitting at during that particular sporting event. As can be discerned, whether as a conventional temporary tattoo on adhesive plastic, or transferable ink, the indica imparted to the individual's person can be individualized to the person and the venue to provide third parties the best possible information to handle a lost or ill individual bearing the imparted indicia.

In addition to the customized information indicia, the indica imparted to the child or adult may include a cartoon or fanciful drawing, or a venue related logo, which the child or parent may pick out from a plurality of available images. In cases where the child picks out the cartoon or image, it will encourage the child to cooperate and make it a more pleasurable experience.

Preferably the information imparted as indicia to the temporary tattoo or other means of temporary impartation to an individual, will provide a person who finds the child when lost a means for direct and immediate way to contact the parent with no electronic interpretation or third party contact. In the current best mode of the device and method herein, the parent or guardian's home telephone number, or more preferred, the parent or guardian's cell phone number, would be one line of information indicia imparted onto the user using temporary means for impartation such as the noted temporary tattoo. Once applied to the child's arm or hand or some other visible part of their person, any third party finding the child will have an immediate means for direct contact with the parent. Of course location of the imparted indicia may also be on a hidden part of the body should the parent, guardian, or security personnel at a particular venue so desire.

As noted, indica bearing immediately discernable information for a direct contact with a parent or guardian is preferred since it provides the quickest means to reunite the child with the parent. Further, since when a child is lost, the parent is generally not too far away, the person finding the child can tell the parent the immediate landmarks adjacent to the child and continually direct the parent approaching on how close they are and if they are going in the right direction.

Such direct contact alleviates the need to take the child to a security station or police station where the parent is tracked down using detective work and reunited with the child after a very long time. Instead, using a cell phone number which is imparted temporarily and directly onto the person of the lost child or adult, the finding party can immediately telephone the parent or guardian and direct them to the proper location in minutes or less.

Further, using the cell phone number of the parent provides an immediate means for an unrelated party finding the lost individual, to identify the parent on his or her arrival. Cell phones are unique to the phone itself and the person carrying it. The person finding the lost child can simply look at the phone number on the cell phone carried by the guardian or parent, to determine if it is a match to the indica on the child or individual, or do a call back to the parent's cell phone to check for the ringing of the parent's phone as a means to identify the parent or guardian. The indica imparted to the person of the child or adult may have instructions to the finding party, to check the cell number of the arriving party subsequent to a call as a means to validate the identity of the responder.

Since very small children are generally shy and have been taught not to talk to or go anywhere with strangers, providing a way to get directly in touch with the parents without trying to interrogate the child also is less traumatic to the child. An additional piece of indicia that can be added to the temporarily imparted indicia is the child's name. In that fashion, a third party, finding a very distraught, crying, or pouting child who has been taught to avoid strangers, will have a means to talk to the child and calm him down using the child's own name. In the instances of parents who might be bringing multiple kids to a venue, it will also provide the person finding the lost child a way to identify the child by name directly to the parent using the cell phone number on the temporary tattoo and the name provided.

The information that is printed upon the individualized temporary tattoos can be done so with the parent and child present on entrance to the venue. In such an application, the parent and child would visit with a venue employee who would take the information from the parent as to the phone number where the parent can be directly contacted by a person finding the child. The parent or child would also provide the child's name, and if desired, pick out the cartoon to accompany the identification and contact information on the tattoo.

The information may be input into a computer having software written for the application. Such software programs generally provide fields on a screen where information is entered. Once all of the necessary information is entered, the computer will be instructed to communicate the proper information to a printer to generate the temporary indicia which is specifically individualized for the child on whom it will be imparted. If a temporary tattoo which is ink imparted, it would then be applied to the skin of the child who for a temporary period will have the parent or guardian's cell phone number and the child's name tattooed on their skin. The conventional temporary tattoo using either adhesive plastic film or transferable ink tattoos would be imparted with the informational indica selected and also imparted to the person of the child or adult as the case may be by applique.

As noted above, since cell phone numbers are personal to the individual phones and displayable on such phones, the cell phone number can provide an additional function. As noted above, small children are frequently incapable of identifying themselves or their parents. Consequently when a parent or guardian shows up to claim the child, it can be hard to determine if the person arriving is in fact the proper parent or authorized guardian. However, by placement of indica on the person of the child, or in some cases adult, and including indica bearing the unique cell phone number of the parent or guardian of the child, upon entering a venue such as an amusement park, a means to identify the parent or guardian to the person finding the child is also provided. If the parent is called to retrieve their child subsequent to the application of the informational indicia using some type of adherence such as the temporary tattoos, the parent can be asked to display the phone number on their cell phone or the finding person can call the cell phone, which will then ring, and prove that the person showing up to retrieve the child is the person who is supposed to be retrieving the child.

The means to impart the indica bearing the information such as the conventional temporary tattoos, could also be generated by computer input from a remote location and either mailed to the parent or delivered to a parent on entry to the venue. In this embodiment of the device and method, the parent or guardian would use a remote computer on a network connected to the computer which generates the tattoo, which may include or provide spaces to enter indicia relating to the cell phone or other phone information, and optionally the child's name, and/or the cartoon character to appear on the final tattoo. In this fashion, the parent could buy a supply of tattoos from a supplier who would mail or otherwise deliver them to the parent at the parent's remote location. This would allow the parent or guardian to buy a long term supply of such impartable information indica, and to have them handy for application to the child to identify both the child and the parent any time the child is going to a venue where they might get lost. In a conventional fashion, conventional pens or markers may also be used to impart indica to such temporary tattoos or plastic adhesive or transferable ink tattoos type body stickers and may be used to supplement the pre-imparted indica bearing the selected information about the wearer and parent or guardian.

Finally, in another optional embodiment of the disclosed device and method, the computer which generates the information to be imparted as indicia to the person of the child or adult, could also have a database in which the child's and parent's information is stored. In this embodiment, as a back up to the parent not being contacted directly, the child and parent's name address and contact information could be stored. In this fashion, if somehow the child becomes lost at a large amusement park or sports venue, or because the parent is incapacitated, or because of some sort of disaster, security personnel would be able to escort the child to a safe station where the child's vital contact information could be identified based on the cell phone number on their arm or some other unique identifier such as a bar code. Security could then call an alternate party to rescue the child if they cannot contact the parent on the cell phone number.

Consequently, by generating wearer-specific indica for impartation to the wearer such as a child, using a temporary tattoo or similar means for placement of the informational indica on the person of specific children, an informational means enabling direct contact with the parent or guardian is provided. Further information in the indicia may be provided as a means for unrelated third parties to speak to the child by name, and a means to identify the parent or guardian who shows up to claim the child based on the parent or guardian's cell phone number being imparted to the child using a temporary tattoo or other means of temporary indicia attachment to the child. Still further, a means to identify alternate emergency contacts is provided if such a database is kept, for instances where the parent or guardian is separated from the child due to the parent or guardian becoming incapacitated or during a disaster or emergency.

With respect to the above description, before explaining at least one preferred embodiment of the invention in detail, it is to be understood that the invention is not limited in its application to the details of construction and to the arrangement of the components or steps set forth in the following description or illustrated in the drawings, nor just to children. The apparatus and methods of the invention are capable of other embodiments and of being practiced and carried out in various ways which will be obvious to those skilled in the art. Also, it is to be understood that the phraseology and terminology employed herein are for the purpose of description and should not be regarded as limiting.

As such, those skilled in the art will appreciate that the conception, upon which this disclosure is based, may readily be utilized as a basis for designing of other structures, methods and systems for carrying out the several purposes of the present disclosed device and method. It is important, therefore, that the claims be regarded as including such equivalent construction and methodology insofar as they do not depart from the spirit and scope of the present invention.

An object of this invention is to provide a method of individual identification of a child which may be applied to the skin or person of a child or adult temporarily.

Another object of this invention is the provision of a method to provide readable indicia bearing information for immediate direct contact with a parent or guardian of a lost child without the need for an interface through any third party.

A further object of this invention is the provision of a means for a third party finding a lost child to determine the child's name and a manner to directly contact the child's parent or guardian without communicating with the child in any fashion.

An additional object of this invention is the provision of temporarily imparted indica a means to identify the contacted parent or lost child's identity and authorization for retrieving the lost child through the use of the cell phone called and possessed by the parent or guardian.

Yet an additional object of this invention is the provision of such temporarily imparted indica as a method for third parties to contact a parent a prior designated alternate parent or guardian in case the primary parent becomes incapacitated or out of touch with their cell phone.

Further objects of the invention will be brought out in the following part of the specification, wherein detailed description is for the purpose of fully disclosing the invention without placing limitations thereon.

### BRIEF DESCRIPTION OF DRAWING FIGURES

FIG. 1 is a top view of the informational indicia generated for application to the person of the child to alert finding persons to the contact information for the parent or guardian of the child such as a cell phone number.

FIG. 2 shows a flow chart of one preferred embodiment of the method where the informational indicia is generated and imparted to the person of a child or adult using means for imparting indica such as a conventional temporary tattoo.

FIG. 3 depicts a flow chart which includes placing the child's name as informational indica on the temporary tattoo.

FIG. 4 is a flow chart showing optional steps where the child's name may be added, alternate contacts stored, and the use of the called cell phone to identify the responding individual.

### DETAILED DESCRIPTION OF THE PREFERRED EMBODIMENTS OF THE INVENTION

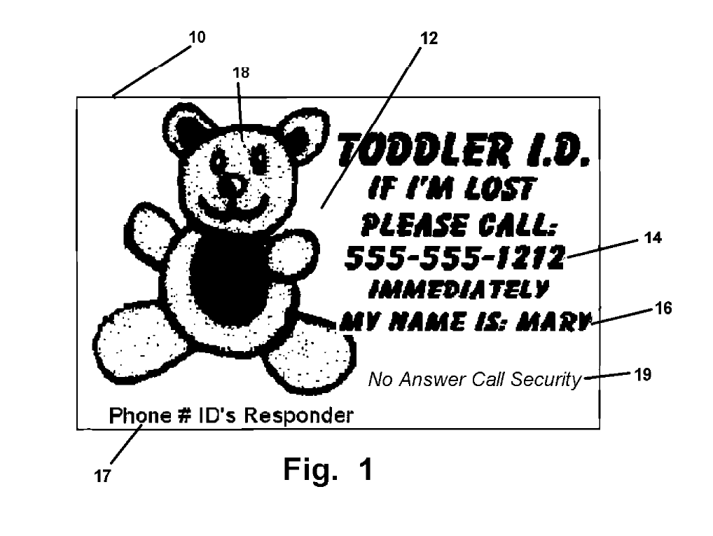

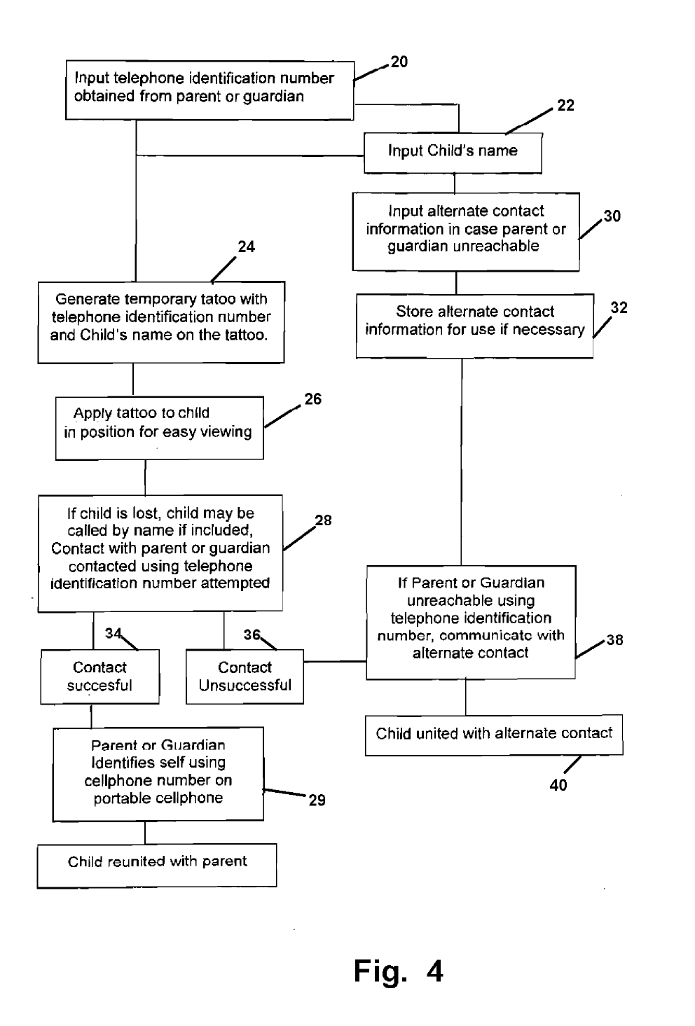

Referring now to the drawings, FIGS. 1-4 depict the various embodiments and employment methods of the herein disclosed device and method. As shown in FIG. 1, the temporary tattoo 12, may be a conventional adhesive backed plastic film type of temporary tattoo 12, employing adhesive-backed polyethylene or other plastic, or otherwise water-resistant but ink acceptable material forming the adhesive backed label 10 which is a flexible planar member. The label 10 is employed for imparting informational indica thereon by printing, stamping, or using a water resistant marker, or combinations thereof, using inks which will not run or bleed when wet. Such temporary tattoos 12 using plastic or other labels 10 for holding the informational indicia, when applied to the skin, will appear as a tattoo 12, and provide contact information in the form of informational indicia. This information provides a means to individually identify the child or adult on whom it is affixed as well as a means to identify and contact a responding parent or guardian to the finding party.

The informational indica on the label 10 most preferably includes a phone number 14, which would preferably be the parent or guardian or caregiver's cell phone number 14. This phone number 14, which would be imparted with the other desired informational indicia, using bleed-resistant and/or water-resistant ink or dye imparted to the label 10 by printing or using a marker, or combinations thereof. The resulting label 10 is adhered to the skin using adhesive on its back as a temporary mode of affixing the tattoo 12 which employ the plastic such as polyurethane film forming the label 10 which is backed with and adhesive adapted to stick to the skin of the wearer and to resist dismounting if wet.

Also, optionally but preferred, indicia providing directions that the depicted phone number 14 provides a means to identify the responder 17 and indicia providing directions to a third party also providing a means for alternate response 19, such as taking the person to security, if the phone number 14 does not work may optionally be included in the informational indica on the label 10.

In the transferable mode of temporary tattoos 12, the informational indicia is imparted to either on the flexible planar member forming the label 10 formed of ink transfer paper or film, or plastic type film or other means for retaining the informational indicia, in a manner which once water is applied and wetted, will allow the transfer of the ink or dye forming the informational indicia to the skin. As noted, conventional temporary tattoos 12 may also employ indica on a label 10 which may be adhesively engaged to the wearer. Those skilled in the art will realize that other means to generate informational indica and temporarily adhere it to the skin may be used and all are considered included in the scope of this patent. However the current preferred mode employs a temporary tattoo 12 for ease of application and generation of the indica to the skin or person.

The indica forming information of the temporary tattoo 12 on the label 10, or when transferred, in addition to indica as to the phone number 14, may also have information on how to best contact the parent or guardian. The informational indica can also include the child's name 16, and optionally a venue related logo or cartoon 18 which can be chosen by the child if desired.

Every individualized tattoo 12, may be easily generated employing a conventional PC style computer operatively connected to an inkjet laser or state of the art printer using conventionally available inks or dyes capable of producing the transferable indica on the customized tattoos 12 on the label 10. The indicia transferred to the skin when the flexible planar member forming the label 10 is wetted or adhered, thereafter provides anyone finding the child or adult, the ability to call them by name, and to contact their parent or guardian directly without being routed through security or another third party, and to identify the responding parent by inspecting the cell phone number on the respondent's cell phone if that is the phone number 14 imprinted.

In use, as a means to identify the child and parent if separated in a venue such as an amusement park, hotel, or an airport, a method can be followed during the entry process or at the beginning of the trip, to generate the indicia for impartation to the child or adult. In a first step 20, during entry to some portion of a venue, the child or adult needing the imparted informational indica providing the information and identification can be taken to a generating station located near a venue entrance. Once there, the parent or guardian will be asked to provide one or a combination of the parent's home or cell phone number 14, the child's name 16, and possibly a specific venue related logo or a cartoon FIG. 18 wanted by the child.

In a simple mode of the device, the indicia imparted to the child would include the child or wearer's name would be input 22 and printed upon the label 10 for adhesion to the skin, or by transfer of ink to the skin. Or the informational indicia could be hand written with a marker to the label 10 which is pre-prepared with other informational indicia, and just needs the phone number 14.

A temporary tattoo 12 of either type would thus be generated 24 which in the current preferred mode uses the precut flexible member forming the label 10 and employs the information provided which is imparted to be imparted to the skin or the person of the child. Informational indicia may be imparted to the label 10 using appropriate software running on an appropriate computing device, and some or all of the desired informational indica bearing the information would be printed to the label 10 for affixing to the child's skin. However, those skilled in the art will no doubt realize that other manner of generating a temporary tattoo with the desired indicia thereon can be used such as the conventional adhesive mode and attachment of the label 10 to the skin or person of the child or adult, and such are anticipated.

Once generated with the desired indicia bearing, the desired information is imparted to the label 10 and the tattoo 12 is imparted to the skin or in some cases the person of the wearer 26. This is done currently using water or another means for a wet transfer, where the planar flexible member forming the label 10 is moistened and the ink forming the indicia of the tattoo is applied to the skin of the child or other person who is to be temporarily identified. If the label 10 mode of temporary tattoos 12 is employed, the planar flexible member forming the label 10 bearing the written or printed informational indica, would be applied to the skin or person of the child or adult using water resistant adhesive which would be on one surface of the label 10.

As noted, in the current best mode of the device, the phone number 14 in the form of a portable cell phone and the wearer's name 16 would at least be imparted to tattoo 12 affixed to the person of the child or adult to be protected. However as noted, the information imparted by the indica imparted to the person of the wearer may be infinitely customized to the user and the venue.

The preferred information imparted to each individual in the informational indicia, would be specific to the individual child or adult to which the imparted indicia containing the information is applied. Further the information may be customized as to the venue or travel mode of the child or adult to which it is imparted, be it an amusement park, beach, school, museum, airport, airplane, bus, cruise ship, hotel or resort, or school or field trip. Such information can include for instance, one or a combination of informational components including, the wearer or individual's name, their age, their parent or guardian's cell phone number, the individual's primary language spoken, any allergies or medical conditions, a venue logo, the individual's blood type, the individual's eye and hair color, a photo image of the responsible parent or guardian, a consent to treatment in case of injury; a flight number & time & destination, a cabin number, a hotel room number and/or name, a bus number, a teacher's name, a classroom number, and/or the wearer's school, a stadium section number, a stadium row or seat number, or any other informational component which if included as indica would customize the provided information for the user and venue.

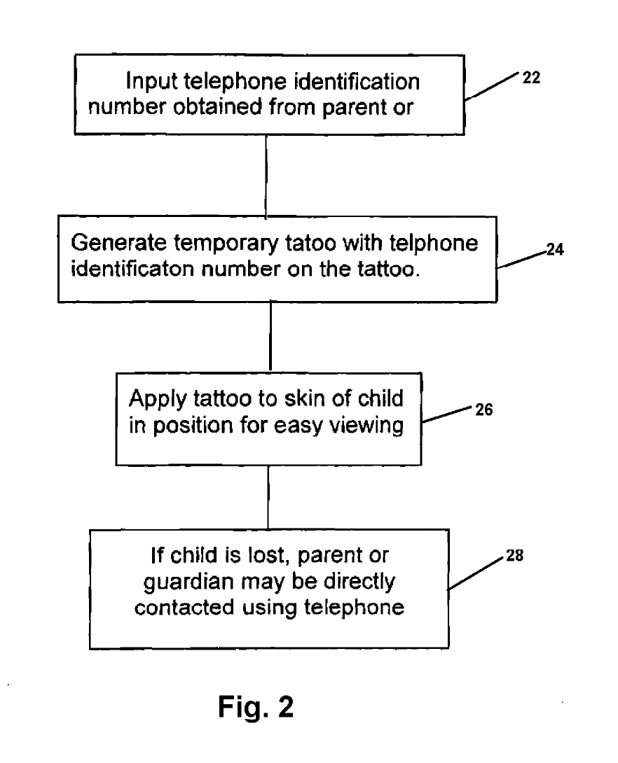

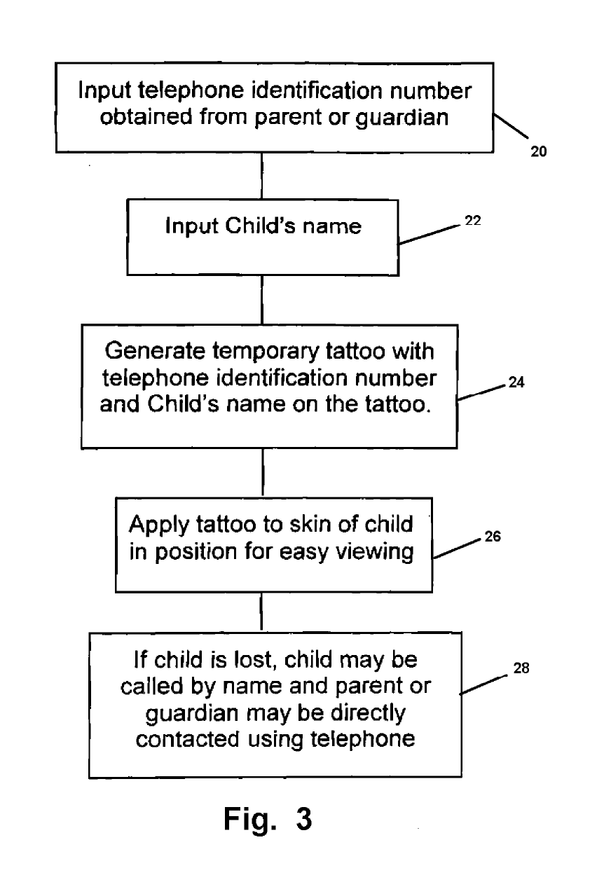

If the child is lost, the finding party views the indicia bearing the information, and can directly contact the parent or guardian 28 using the phone telephone number 14 and thereafter use the phone number as a means to identify the responding parent or guardian on arrival. If added to the indicia as in FIG. 3, the name of the wearer of the tattoo provides the finding party a means to identify the name of the child and converse with him or her and identify the individual child to a responding parent. However, the informational indicia included in the tattoo 12 without the name being added as shown in FIG. 2 could be employed if the name is not desired. Employing the name would be most useful in cases where a parent or guardian might have multiple children in the same venue at the same time especially if the children are traveling in a group without the adult.

If the wearer of the temporary tattoo 12 becomes lost, the finding party can talk with the child by name and call the parent or guardian directly. Once the responding parent arrives, should he or she be challenged by the finding party as to their identity, they need only display their cell phone number or make a second call to the parent's cell phone, to check for the ringing of the parent's phone or the finding party, as a means to identify them as the proper parent or guardian.

In a similar method of operation of the apparatus and device, the temporary tattoos 12 could also be generated by computer input from a remote location. They would then be delivered to the parent or guardian prior to entry into a venue, or for everyday use in a plurality of different venues. This embodiment would facilitate the provision of the temporary decals or tattoos 12 by allowing input 20 over the internet, or in a self service mode at a venue using an ATM style machine that can print the tattoo.

In this embodiment of the device and method, the parent or guardian would use a remote computer or ATM connected to a computer network which would communicate input information to a computer and printer to generate the tattoos on the planar flexible member forming the label 10. The parent or guardian would input one or a combination of a telephone number 14, the child's name 16, and a preferred design or cartoon 18. The minimum input of course would be the telephone number 14. The planar flexible member forming the labels 10 with the tattoo generated upon them would then be mailed or otherwise delivered to the parent or guardian and applied and used as noted above. Of course the labels 10 can be pre-printed with instructional indica as to calling the phone number 14 and using it to identify the responder, and leave spaces where the phone number 14 may be written using a marker or other device which uses water-resistant ink. In all modes of the device and method the indica is impartable to the planar flexible member forming the label 10 by employing one or a combination of indicia imparting devices from a group of indicia imparting devices including a computer operated printer and a marker having water-resistant ink, to impart said indica upon said planar member. The marker might be a water resistant pen or a felt pen or the like employable by hand to add some or all of the required indicia to the planar member forming the label 10.

In a third embodiment of the method of employing the tattoo, the computer to which the information input from the parent and which generates the tattoos, can also store the input information in a database. This embodiment would use the same steps as FIG. 2 and FIG. 3, but would add additional steps for input as a back up, if the parent not being contacted directly, the child and parent's name address and contact information could be input 30 stored 32. If the child is lost and the parent can be contacted directly 34, the system works the same as above in that contact with the parent is handled by use of the telephone number 28 and the responding parent or guardian can identify themselves 29 when they find the child.

However, if the parent or guardian cannot be contacted 36 the child would be taken to the appropriate security which would be able to identify the child by the telephone number 14 on the tattoo. Security could then call the alternate party 38 input at origin but not added to the indicia of the tattoo, to rescue the child if they cannot contact the parent on the telephone number 14, thereby providing a means to identify alternate emergency contact in instances where the parent or guardian is separated from the child and unreachable. The child or person wearing the tattoo would then be united with that alternate contact 40.

While all of the fundamental characteristics and features of the present method and apparatus of the disclosed invention have been described herein, with reference to particular embodiments thereof, a latitude of modification, various changes and substitutions are intended in the foregoing disclosure and it will be apparent that in some instance, some features of the invention will be employed without a corresponding use of other features without departing from the scope of the invention as set forth. It should be understood that any such substitutions, modifications, and variations may be made by those skilled in the art without departing from the spirit or scope of the invention. Consequently, all such modifications and variations are included within the scope of the invention as defined by the following claims.

What is claimed is:

1. A method for identifying a lost person and providing contact information to directly communicate with their guardian comprising the steps of:
collecting a cellular telephone number from said guardian;
imparting indicia upon the person of a second person for whom said guardian is responsible;
including in said indicia, said cellular telephone number and directions to contact said guardian using said telephone number; and
including in said indicia, instructions to employ said telephone number as a means to identify said guardian by matching said cellular telephone number included in said indicia to a displayed number on said guardian's cellular phone, or by a calling of said cellular telephone number while said guardian is proximate and an ascertaining if said cellular phone rings.

2. The method for identifying a lost person of claim 1 additionally comprising:
imparting said indicia upon the person of said second person by affixing a temporary tattoo bearing said indica, upon said second person.

3. The method for identifying a lost person of claim 2 additionally comprising:
imparting said indicia upon the person of said second person by an affixing of a flexible planar member, bearing said indicia, upon said second person as said temporary tattoo bearing said indica.

4. The method for identifying a lost person of claim 2 additionally comprising:
imparting said indicia upon the person of said second person by an affixing of transferable ink which was imparted on a flexible planar member, to the skin of said second person as said temporary tattoo bearing said indica.

5. The method for identifying a lost person of claim 3 additionally comprising:
employing one or a combination of indicia imparting devices from a group of indicia imparting devices including a printer and a hand-employable marking device having water-resistant ink, to impart said indica upon said planar member.

6. The method for identifying a lost person of claim 4 additionally comprising:
employing one or a combination of indicia imparting devices from a group of indicia imparting devices including a printer and a hand-employable marking device having water-resistant ink, to impart said indica upon said planar member.

7. An apparatus for identifying the guardian of a person who becomes lost to a third party comprising:
a planar member configured hosting indicia printed thereon;
means to temporarily impart said indicia upon said person;
said indicia including a cellular telephone number of said guardian;
said indicia including directions to call said cellular telephone number should said person become lost;
said indicia further including directions to employ said cellular telephone number as a means to identify said guardian by viewing a displayed number on a cellular telephone carried by said guardian, or by a dialing of said cellular telephone number when said guardian is proximate said third party.

8. The apparatus for identifying the guardian of a person who becomes lost to third parties of claim 7 wherein said means to temporarily impart said indicia upon said person comprises:
said formed of transferable ink imparted to said planar member, said ink being transferable to the skin of said person.

9. The apparatus for identifying the guardian of a person who becomes lost to third parties of claim 7 wherein said means to temporarily impart said indicia upon said person comprises:
said indica transferable to the skin of said person by an adhering of said planar member to said person.

10. The apparatus for identifying the guardian of a person who becomes lost to third parties of claim 7 additionally including:
said indicia including the name of said person.

11. The apparatus for identifying the guardian of a person who becomes lost to third parties of claim 8 additionally including:
said indicia including the name of said person.

12. The apparatus for identifying the guardian of a person who becomes lost to third parties of claim 9 additionally including:
said indicia including the name of said person.

13. The apparatus for identifying the guardian of a person who becomes lost to third parties of claim 7 additionally including:
said planar member being formed of plastic material having a first side configured to receive said indica and having adhesive pre-positioned on a second side.

14. The apparatus for identifying the guardian of a person who becomes lost to third parties of claim 9 additionally including:
said planar member being formed of plastic material having a first side configured to receive said indica and having adhesive pre-positioned on a second side.

15. The apparatus for identifying the guardian of a person who becomes lost to third parties of claim 12 additionally including:
said planar member being formed of plastic material having a first side configured to receive said indica and having adhesive pre-positioned on a second side.
